(19) United States
(12) Patent Application Publication
(10) Pub. No.: US 2026/0225249 A1
(43) Pub. Date: Aug. 6, 2026

(54) CONTROL METHODS AND INTERFACES FOR CONTROLLING MACHINES

(71) Applicant: Massachusetts Institute of Technology, Cambridge, MA (US)

(72) Inventors: Hermano Igo Krebs, Watertown, MA (US); Moises Alencastre-Miranda, Cambridge, MA (US); Andres Martinez Guerra, Redwood City, CA (US)

(73) Assignee: Massachusetts Institute of Technology, Cambridge, MA (US)

(21) Appl. No.: 19/150,173

(22) PCT Filed: Jan. 22, 2024
(86) PCT No.: PCT/US2024/012469

§ 371 Date: Jul. 22, 2025

Related U.S. Application Data
(60) Provisional application No. 63/481,021, filed on Jan. 23, 2023.

(51) Int. Cl. B25J 9/16; B25J 9/10; B25J 19/00

(52) U.S. Cl. CPC B25J 9/1689; B25J 9/106; B25J 19/0016

(57) ABSTRACT

Embodiments related to methods and systems for using control arms operated in a controller space that is linearly mapped to a world space for controlling operation of a machine with an end effector are disclosed.

### CROSS-REFERENCE TO RELATED APPLICATIONS

This application claims the benefit under 35 U.S.C. § 119(e) of U.S. provisional application Ser. No. 63/481,021, filed Jan. 23, 2023, the disclosure of which is incorporated by reference in its entirety.

### FIELD

Disclosed embodiments are related to control methods and interfaces for controlling machines.

### BACKGROUND

Controllable arms and excavation machinery are pervasive across many industries such as construction, infrastructure work, mining, surgery, shipping, logistics, and others. The operation of such machines is undertaken by skilled operators who may become experts at performing the various tasks by harnessing the full capabilities of the machine. Despite the high demand for trained operators there is a distinct shortage of capable operators since acquiring the appropriate training requires significant time and practice. Furthermore, the often times harsh and remote working conditions may make these jobs particularly arduous and unappealing. The harsh working environments may also induce worker fatigue, leading to reduction in productivity and work quality during work sessions of relatively long lengths of time. This shortage of skilled operators increases cost and extends timelines associated with construction projects. Conversely, in low and middle-income countries, there is also a labor shortage due to lack of training.

### SUMMARY

In one embodiment, a system comprises: a control arm including a plurality of linkages with one or more joints disposed between the plurality of linkages; a plurality of sensors configured to sense a configuration of the one or more joints of the control arm; and at least one processor configured to: obtain a commanded pose for an end effector of a machine in a world space, wherein the commanded pose is in a controller space, and wherein the commanded pose is obtained from the plurality of sensors, and wherein the controller space is linearly mapped to the world space of the machine; transform the commanded pose from the controller space to a commanded machine configuration in a machine space of the machine; and control movement of the end effector based at least in part on the commanded machine configuration.

In one embodiment, a method of controlling operation of a machine including an end effector comprises: obtaining a commanded pose for the end effector in a world space, wherein the commanded pose is in a controller space, wherein the controller space is linearly mapped to the world space of the machine; and teleoperating the machine based at least in part on the commanded pose to control movement of the end effector.

In one embodiment, a method of controlling operation of a machine including an end effector comprises: obtaining a commanded pose for the end effector in a in a world space, wherein the commanded pose is in a controller space, wherein the controller space is linearly mapped to the world space of the machine; transforming the commanded pose to a commanded machine configuration in a machine space of the machine; and controlling movement of the end effector based on the commanded machine configuration.

In one embodiment, a method of controlling operation of a machine including an end effector includes: obtaining a commanded pose of the end effector in a controller space, wherein the controller space is linearly mapped to a world space of the machine; transforming the commanded pose in the controller space to a commanded machine configuration in a machine space; and controlling operation of the machine based on the commanded machine configuration to control movement of the end effector.

In one embodiment, a machine includes: an end effector; a control arm including a plurality of linkages with one or more joints disposed between the plurality of linkages; a plurality of sensors configured to sense a configuration of the one or more joints of the control arm; and at least one processor. The processor may be configured to: obtain a commanded pose of the end effector in a controller space, where the controller space is linearly mapped to a world space of the machine; transform the commanded pose in the controller space to a commanded machine configuration in a machine space of the machine; and control operation of the machine based at least in part on the commanded machine configuration to control movement of the end effector.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a controllable machine according to some embodiments;

FIG. 2 depicts a control arm according to some embodiments;

FIG. 3 depicts a method of controlling a machine according to some embodiments;

FIG. 4 is a graph of time to perform a task both pre and post training for different controller types;

FIG. 5 depicts a schematic embodiment of a system for implementing the systems and methods disclosed herein; and

FIG. 6 depicts a controllable machine operatively coupled to a controller and a control arm according to some embodiments.

### DETAILED DESCRIPTION

There are many challenges associated with training operators to operate machines such as excavators and other machines, including teaching an untrained operator to understand the often complex and/or non-linear controls associated with the machine (e.g., the multiple separate joysticks associated with the various different joints of the machine). An untrained operator must learn and memorize a model or map specific to the machine to transform the desired world-space movement into a joint-space, or other type of machine space, of the machine. The operator learns how to operate the machine through many (e.g., thousands) of control movement repetitions, which is time and cost intensive. For example, training an operator how to properly operate an excavator may require years (e.g., 3 to 5 years) until the operator is skilled and proficient in commanding the excavator. Thus, training operators on typical machines may be considered the process of learning a non-linear transformation map from a machine joint-space interface to provide a desired world-space operation. In the example of an excavator, the excavator control system has a complex and non-linear behavior, typically controlled via a pair of joysticks commanding the joint velocity of the 4 degrees-of-freedom (DOF) of the excavator (i.e., cab, boom, stick, and bucket). During training, an operator must learn and/or memorize a model or map to transform the world-space requirement into the 4-DOF excavator joint-space commands. Interactions with real world environments may also include an additional non-linear transformation of the joint movement of the machine to account for the interaction point of the machine (e.g., a bucket of the excavator) with the environment. Accordingly, to properly operate a machine, trained operators have learned a complete non-linear map that transforms the desired goal at the point of interaction with the environment into a set of corresponding movements of the joints of the machine. This is a non-trivial task which limits the ability of operators to quickly become proficient with operation of a machine including such controls.

In view of the above, the inventors have recognized the benefits associated with the construction and use of controls with a more intuitive interface that reduces and/or simplifies the mental transformations an operator needs to learn to proficiently operate a machine. Specifically, the inventors have recognized the benefits associated with the use of a control arm which may have a controller space corresponding to a scaled down linear map version of the movements made by the corresponding real world space of the machine. Such a controller may be referred to as a world space interface controller in some embodiments. This movement of the control arm may be transformed to a machine space for implementing the commands from an operator as elaborated on further below. This may reduce or eliminate the operator burden associated with learning and memorizing a mental non-linear map from traditional machine space commands (e.g., joint space velocity commands controlled using a joystick) to world space commands (e.g., actuation of excavator joints).

As noted above, the inventors have recognized the benefits associated with controlling operation of a machine including an end effector using commands received from a control arm with a controller space that may be linearly mapped to a world space surrounding the machine. Such a control method may include receiving commands from a control arm including a plurality of linkages with one or more linear joints (e.g., one or more prismatic joints or any other linearly translatable joints) or rotatable joints (e.g., one or more rotary joints or any other type of rotatable joint)disposed between the plurality of linkages of the control arm where the configuration of the control arm may correspond to a commanded pose of the end effector. Thus, the method may include obtaining a commanded pose of the end effector in a controller space from the control arm and transforming the commanded pose in the controller space to a commanded machine configuration in a machine space. The machine may then be controlled based on the commanded machine configuration. For example, an arm, or other supporting structure of the machine including one or more actuators (e.g., a cart, telescoping joint, rotatable joints, or other actively actuated system associated with the end effector), may be operated to assume the commanded machine configuration. In the case of the machine including an arm, rotatable joints of the arm may be rotated to a commanded set of angles. This may move the end effector to the commanded pose in the world space to interact with the real world environment in the manner commanded by the operator.

As noted above, in some embodiments, a control arm may include a plurality of linear or rotatable joints and linkages. In some embodiments, the linear or rotatable joints and linkages of the control arm may have a similar scaled down construction as an arm including a plurality of linear or rotatable joints and linkages of a real world or simulated machine. For example, a control arm may have the same number of linkages and rotatable joints with the same relationships between the linkages and joints as in an arm of the machine, though scaled down to a size appropriate for use by an operator. Of course, interface linkages and linear or rotatable joints with layouts different from the machine they are used to command are also contemplated. For example, a control arm may be used to command operation of a machine such as a crane that does not include an arm and/or the control arm and arm of the machine may have a different construction. Additionally, in some embodiments, the machine being controlled using the world space interface controllers disclosed herein may be a simulated machine that takes the commands from the controller and determines corresponding movement of the simulated machine based on the received commands. Thus, the disclosed systems and methods should not be limited to any specific construction of the control arm and/or the portion of a machine it is used to control as the disclosure is not limited in this fashion.

During use, the linear or rotatable joints of a control arm may be manipulated (i.e., moved) by an operator to a commanded configuration. In some embodiments, moving the control arm may include an operator applying force to some portion of the control arm (e.g., a handle disposed on the control arm) to move one or more linear or rotatable joints and one or more interface linkages to a commanded configuration. Optionally, the linear or rotatable joints may be configured to support at least a portion of the weight of the control arm. For example, springs and/or actuators may be associated with the plurality of joints to support at least a portion of the weight of the control arm to assist the operator in moving the interface linkages and to help avoid operator fatigue. The control arm may also include one or more sensors configured to sense one or more parameters that may be used to determine a commanded pose of an end effector. For example, the one or more sensed parameters may be used to determine the configuration of the control arm (i.e., the commanded configuration). For example, the control arm may include one or more encoders, potentiometers, displacement sensors, angle sensors, inertial measurement units, accelerometers, gyroscopes, and/or any other appropriate sensor configured to measure a parameter that may be used to determine a configuration of a linear or rotatable joint and/or adjacent linkages of the control arm. In some such embodiments, one or more sensors may be configured to sense an angle of one or more rotatable joints. Additionally or alternatively, one or more sensors may be configured to sense displacement of one or more linear joints.

In some embodiments, movement of a control arm may be used to command a position of an end effector of a machine and a secondary control may be used to command an orientation or other operation associated with an end effector or other portion of a machine. For example, a control arm may also include one or more secondary controls (e.g., pull levers, switches, buttons, interface screens, telescoping joints, knobs, other appropriate controls, and any combination thereof) that are configured to control operation of one or more portions of the corresponding machine. For example, the control arm may include a button or pull lever disposed on a handle grasped by an operator of the control arm that is configured to control an orientation, or other operation of the machine and/or end effector. In one such embodiment, the secondary control may control the orientation of an end effector bucket of an excavator relative to a distal end portion of the arm of the excavator. Of course, other types of operations and/or secondary controls associated with a handle of a control arm may also be used as the disclosure is not so limited.

The presently disclosed methods and control systems are not limited to any particular machine or device, and accordingly may be used to control the operation of any appropriate machine or device. In some embodiments, this may include controlling operation of a machine with an arm including a plurality of linear or rotatable joints and corresponding linkages. In such an embodiment, the machine space may correspond to a joint space including angles associated with each joint. For example, a control arm configuration may be transformed to provide corresponding commanded angles for the joints of the arm of the machine. An excavator is just one example of such a machine including a controllable arm (e.g., the boom and stick of the excavator). However, the disclosed systems and methods may also be applied to other machines including one or more portions that are commanded to provide a desired movement. For example, excavators, cranes (e.g., overhead cranes, tower cranes, ship-to-shore cranes, etc.), bull dozers, skid-steer loaders, robotic arms remotely controlled by joysticks, other appropriate types of construction equipment, and/or any other machine including one or more portions that may be controlled to output a desired movement of an end effector. Thus, it should be understood that the movement of an end effector associated with these different types of machines may correspond to operation of a number of different types of components including, but not limited to: linear or rotatable joints, rotatable drums to wind/unwind wire ropes; telescoping joints; trolleys; rail mounted components; and/or any other component that may be actuated to affect the position and/or orientation of an end effector of the system.

As used herein, the term “end effector” may refer to a component of a machine configured to interact with the surrounding environment. For example, the end effector of an excavator may be a bucket that interacts with the surrounding environment by digging, pushing, compacting, scraping, crushing, or performing any other appropriate action to the surrounding environment commanded by an operator. Other appropriate types of end effectors may include, but are not limited to: buckets; drills; hammers; rakes; thumbs; grapples; couplers; multi-processors; compactors; augers; forks; pulverizers; rippers; a spreader of a container crane configured to be attached to and lift containers; connectors attached to a distal end portion of a wire rope of a crane; grippers connected to a robotic arm; surgical tools located on a distal end portion of a robotic arm; and/or any other appropriate type of end effector configured to interact with an environment surrounding a machine as the disclosure is not so limited.

As used herein, the “configuration” of a control arm and/or a controllable portion of a machine (e.g., an arm or other appropriate portion of a machine) may refer to relative positioning and orientation of the associated components in the control arm or machine. For example, for an arm including a plurality of linkages a configuration may be defined in terms of the angles between the different linkages. Alternatively, the configuration may correspond to the positioning and extension of a wire rope of a crane to position an end effector at a commanded position and/or orientation. Thus, regardless of the specific parameters associated with a given control arm and/or machine, the configuration may describe a position and/or orientation in space of the control arm and/or a controlled portion of a machine. Depending on the context, a configuration may be described in a controller space, machine space, or world space. For example, a configuration of an end effector (e.g., bucket of an excavator) may include a position and/or orientation of the end effector in a world space while the position and/or orientation of the bucket may also be defined as a configuration of the excavator arm in the machine space. Similarly, the associated control arm may include a configuration defined in terms of the controller space.

Different reference frames are discussed throughout the current disclosure including a controller space, machine space, and world space. A world space may describe a reference frame of the real world and/or surrounding environment which a machine is located in and may interact with. For example, movement of an end effector in the world space corresponds to the observed physical movement of the end effector within the surrounding environment. Similarly, a controller space may refer to a reference frame of a control arm where movement of the control arm is within the controller space. In some embodiments, the controller space may be linearly mapped to the world space such that a movement in the controller space results in a corresponding scaled (up or down) movement of the end effector in the world space. In contrast, machine space may refer to the reference frame of the portion of the machine that moves (e.g., an arm of an excavator or other controllable portion of the machine). This may include commanded positions, angles, extension distances, or other appropriate parameters that may be used to characterize a configuration of a controllable portion of a machine. For example, in the instance of an arm including a plurality of rotatable linkages and corresponding rotatable joints between the linkages, a machine space may correspond to the angles of each joint. In such an embodiment, the machine space may be referred to as a joint space. Though it should be understood that other types of machines spaces are contemplated as the disclosure is not limited to any specific type of controllable machine including an end effector.

As used herein, a pose may refer to a position and orientation of a component within a specific reference frame. For example, a pose of an end effector may refer to both the position and orientation of the end effector within a particular reference frame. In terms of a world space reference frame, the pose of the end effector may refer to the position and orientation of the end effector in the surrounding environment. However, it should be understood for purposes of this disclosure that the various embodiments disclosed herein that reference controlling a pose of a particular component also include controlling a position or orientation of the component as the disclosure is not limited in this fashion.

As discussed further below, determining the pose of an end effector (e.g., position and orientation of the end effector of the control arm) may include using forward or inverse kinematics. Forward kinematics may use kinematic equations to determine the pose of an end effector using known values for joint parameters (e.g., sensed angles). Inverse kinematics may use kinematic equations to determine the joint parameters needed to achieve a corresponding end effector pose.

Any of the embodiments related to systems described herein including a machine and/or world space controller may be implemented in any number of ways. For example, a system may be implemented using direct control where any of the disclosed control systems (e.g., a world space controller) is integrated directly into a machine. Alternatively, any of the disclosed systems may be implemented using teleoperation where a machine being controlled and the world space controller used to control the machine are remotely located from one another and sensor signals and control signals are transmitted between the world space controller and the machine using any appropriate communication protocol including wired communication protocols, radio communication protocols, wireless network communication protocols, cellular communication protocols, and/or using any other communication method and/or system capable of transmitting information and commands between the machine and world space controller. Thus, it should be understood that any of the embodiments of methods and systems disclosed herein may be implemented either as a single integrated system and/or as a system where a machine is remotely located from the control system (i.e., a world space controller) that is used to teleoperate the machine. For the sake of clarity, the below embodiments and examples reference the use of an excavator. However, as noted above, the various embodiments disclosed herein may be applied to any appropriate type of machine including one or more portions whose movement may be controlled to interact with a surrounding environment as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

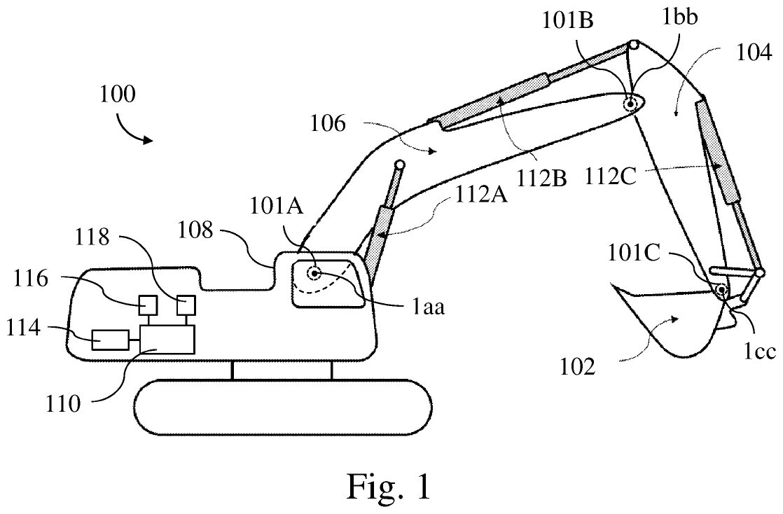

In some embodiments, an excavator 100, i.e., a machine, may include an overall excavator structure that includes a boom 106, an arm 104, and a bucket 102, as shown in FIG. 1. The boom 106 may be rotatably coupled to a body 108 of the excavator 100 such that it can be pivoted about a rotatable joint 1aa connected to the body 108. Correspondingly, the arm 104 is rotatably coupled to the boom 106 such that it can be pivoted about a rotatable joint 1bb between the arm 104 and the boom 106. Similarly, the bucket 102 is rotatably coupled to the arm such that it can be rotated about a rotatable joint 1cc between the arm 104 and the bucket 102. The arm 104 and the boom 106 may serve as individual linkages which, in conjunction with rotatable joints 1aa, 1bb, and 1cc, are operated to create a desired range of movements and orientations of the bucket 102 along a commanded path and move to a commanded machine configuration.

Specifically, a controller 110 of the excavator 100 may include one or more processors configured to control one or more actuators 112A, 112B, 112C coupled to each of the separate linkages for controlling operation of the actuators, and thus, movement of the linkages relative to each other and the excavator body 108. For example, an actuator 112A extending between the body 108 and the boom 106 controls orientation of the boom 106 relative to the body 108, an actuator 112B extending between the boom 106 and the arm 104 controls orientation of the arm 104 relative to the boom 106, and an actuator 112C extending between the arm 104 and the bucket 102 controls orientation of the bucket 102 relative to the arm 104. In some embodiments, the actuators 112 may include sensors 101A, 101B, and 101C, that may transmit signals to the controller 110 regarding one or more operating parameters of the actuators (e.g., extension length, joint angle, etc.).

In the figure, the actuators 112A, 112B, 112C are depicted as cylindrical hydraulic actuators. However, it should be understood that the actuators may correspond to any appropriate actuator capable of controlling movement of a linkage including, but not limited to, various linear actuators, rotational actuators, hydraulic actuators, electrical actuators, pneumatic actuators, thermal actuators, magnetic actuators, combinations of the foregoing, and/or any other appropriate type of actuator as the disclosure is not limited in this fashion.

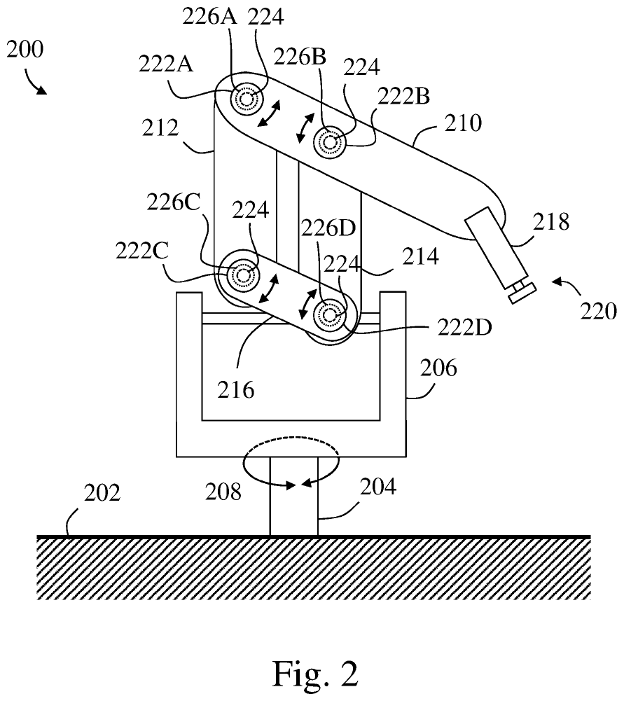

The depicted excavator may also include an operator interface 114 that may be operatively coupled to the controller 110 such that the operator interface 114 transmits commands to the controller 110. For example, the operator interface 114 may transmit control arm configurations from a control arm to the controller 110. In some embodiments, the control arm may correspond to a control arm similar to that depicted in FIG. 2, though any other appropriate type of control arm may also be used as the disclosure is not so limited. Additionally, the excavator 100 may optionally include one or more joysticks 116 operatively coupled to the controller 110 which may be used to control the velocities of the bucket 102, arm 104, boom 106, and body 108 in some embodiments. The joysticks 116 may control the velocities by actuating one or more of the actuators 112. Further, the excavator 100 may include one or more pedals or levers 118 operatively coupled to the controller 110 used to control the velocity of treads and/or wheels to move the entire excavator or other appropriate machine depending on the embodiment. The controller 110 may include one or more processors and associated non-transitory computer readable memory that includes instructions that when executed cause the system to perform any of the disclosed methods. Specifically, as elaborated on further below, upon receiving the control arm configuration from the operator interface, which may correspond to the commanded pose of an end effector in the controller space, the controller 110 may transform the commanded pose in the controller space to a machine configuration in a machine space prior to actuating the actuators 112 accordingly to move the end effector (i.e., bucket 102) to the commanded pose.

While a bucket is illustrated in the figure, in some embodiments, the excavator 100 may include an end effector other than the bucket 102 coupled to the arm 104. For example, the end effector of the excavator may include a drill, hammer, rake, thumb, grapple, coupler, multi-processor, compactor, auger, forks, pulverizer, ripper, any other appropriate type of end effector. Additionally, end effectors for use with other types of machines may also be used in some embodiments as noted previously.

It should be understood that an excavator is one example of a machine that may utilize the present disclosure and that any other appropriate machine may also utilize the present disclosure as the disclosure is not so limited. For example, a variety of cranes may implement the systems and method disclosed herein. One specific example includes a container crane (i.e., container handling gantry crane, or ship-to-shore crane). In some embodiments, a container crane may include a fixed arm (i.e., boom) with a cabin (i.e., trolley) and spreader operatively coupled to the fixed arm. The cabin may be movable in a direction of a longitudinal axis associated with the fixed arm. The spreader may also be movable in a direction parallel to a local direction of gravity such that the spreader may move side to side as well as up and down during operation. During operation, the spreader may grasp a load such as a container or other cargo, and the spreader holding the container may be moved to transport the container. In such an embodiment, the spreader may be considered the end effector of the crane. In other embodiments, a crane may include other end effectors.

A control arm 200 which may be used as an operator interface according to some embodiments is shown in FIG. 2. The control arm 200 may include a handle 218 configured to be grasped by an operator's hand for applying forces to the control arm 200 for manipulating the overall configuration of the control arm 200. The control arm 200 may include a plurality of rotatable linkages joined together by a corresponding plurality of rotatable joints. The handle 218 may include a secondary control 220 as described previously above. The handle 218 may be coupled to a first end portion of a first linkage 210. The first linkage 210 may be attached to a second linkage 212 and a third linkage 214 by rotatable joints 222A, 222B, respectively, on a first portion of the first linkage 210 which is positioned opposite from a second portion of the first linkage 210 which the handle 218 is coupled to. The second and third linkages 212, 214 may be coupled to a fourth linkage 216 that extends between and is rotatably coupled to end portions of the second and third linkages 212, 214 by rotatable joints 222C, 222D, respectively. In the depicted embodiment of FIG. 2, the fourth linkage 216 is coupled to a bottom portion of the second linkage 212 and a bottom portion of the third linkage 214, and the first linkage 210 is coupled to a top portion of the second linkage 212 and a top portion of the third linkage 214 such that the second linkage 216 and the first linkage 210 are coupled to opposite ends of the second linkage 212 and the third linkage 214 from one another. In the depicted embodiment, the third and/or fourth linkages 214 and 216 may be rotatably coupled to a support 206 which correspond to any structure configured to support a proximal portion of the control arm 200. In the depicted embodiment, the rotatable coupling 222D associated with the third and fourth linkages 214 and 216, is connected to the support 206. Thus, forces applied to the handle 218 may cause rotation of the separate rotatable joints 222A-222D and corresponding movement of the linkages 210, 212, 214, 216 relative to the support 204 and each other as the handle 218 is moved between different positions in a plane perpendicular to the axes of rotation of the different rotatable joints 222. This may correspond to changes in a position of the handle 218 in both the vertical and horizontal directions relative to a local direction of gravity. This movement may correspond to changes in vertical and horizontal position within a controller space of the control arm and/or a machine space of the excavator.

The support 206 may be coupled to a rotatable coupling 204 such as a rotatable shaft or other appropriate rotatable structure capable of supporting the support 206. Thus, rotation of the support 206 and the associated rotatable coupling 204 may permit the entire control arm 200 to yaw about the rotation axis of the support as shown by arrows 208. The rotational movement of the support 206 may correspond to a yaw in the controller space and/or machine space in some embodiments. The rotatable coupling 204 may be coupled to a base 202 which may support the overall control arm 200 thereon. The base may take any appropriate shape or form as the disclosure is not so limited. In some embodiments, the base 202 may be located on some portion of an excavator 100, such as within the body 108.

While a specific control arm 200 is shown above, it should be understood that other control arm configurations with different numbers, arrangements, and/or shapes of linkages may be used as the disclosure is not so limited. For example, a simple arm with a handle and two serially coupled linkages with two rotatable joints may be used, or more complex arms with any number of linkages and rotatable joints may be used as the disclosure is not limited to any specific control arm construction.

As discussed previously, one or more sensors 226A-226D may be coupled to any appropriate portion of the control arm 200 to sense a configuration of the control arm during operation. In some embodiments, the one or more sensors 226A-226D may be encoders configured to determine the angle of the rotatable joints 222 between the different linkages 210-216. Also, an encoder may be coupled to the rotatable coupling 208 to determine the yaw angle of the support 206 relative to the base 202. The angles, or other parameters, measured by the sensors 226A-226D may be used at least in part to determine a configuration of the control arm 200 to determine a commanded pose of the end effector. For example, the sensed angles, or other parameters, may be output to a separate controller of the excavator, or other machine, to implement the commands input to an operator using the control arm.

In some embodiments, it may be desirable to support at least a portion of a weight of an arm of an operator and/or the control arm to help avoid operator fatigue. Thus, as noted previously, the rotatable joints 222 may include one or more biasing members 224 corresponding to springs and/or actuators associated with the different rotatable joints. The biasing members may be configured to apply a torque, or other appropriate force, to the rotatable joints to support at least a portion of the weight of the control arm and/or the operator's arm. Supporting the weight of an operator may serve to reduce the forces applied by an operator to command a desired pose using the control arm which may help to prevent fatigue of the operator. The biasing members may be any appropriate biasing members such as torsion springs, compression springs, tension springs connected to separate linkages, any other appropriate spring, motors, and/or any combination thereof. Additionally, while biasing members have been depicted at each joint, it should be understood that the biasing members may be associated with any one or more of the joints and/or other portions of the linkages of the control arm. For example, a spring might extend between adjacent linkages to apply a desired biasing force. Thus, any appropriate configuration may be used to apply the desired biasing force to offload at least a portion of a weight of the control arm in such an embodiment.

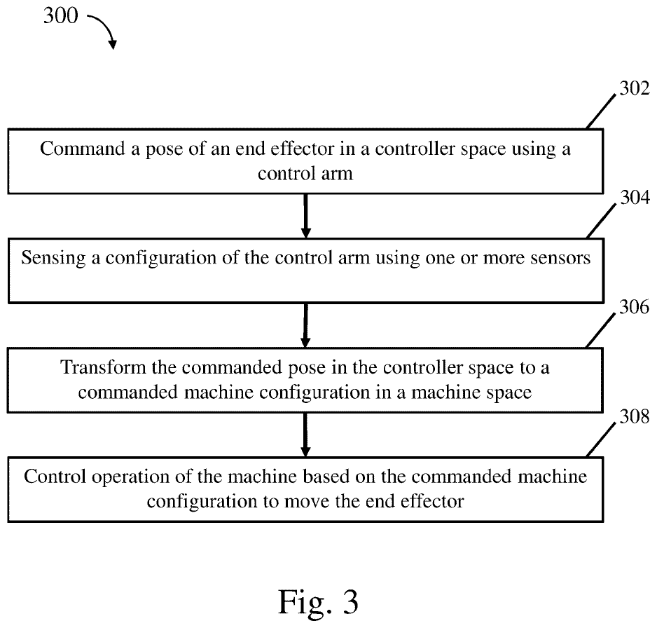

A method 300 of controlling operation of a machine according to some embodiments is depicted in the diagram shown in FIG. 3. For example, a control arm 200 such as that depicted in FIG. 2, or any other appropriate embodiment of a control arm, may be used in conjunction with the method 300 to control operation of a machine (e.g., the machine 100 shown in the depicted embodiment of FIG. 1). As previously described, a control arm may include a plurality of linkages and rotatable joints and may be manipulated into different configurations within a controller space. These configurations formed by moving the control arm may be referred to as a commanded configuration or a control arm configuration. For example, moving a handle within the permitted configurations may be used to command a corresponding movement of an end effector of a machine in the world space. This movement of the control arm may be linearly related to a corresponding movement in the world space in some embodiments as previously noted. In some instances, the command from a control arm may be a commanded pose of an end effector, though embodiments in which the control arm configuration corresponds to a commanded position are also envisioned. In either case, an operator may manipulate the handle of the control arm to command a pose of the end effector in a controller space using the control arm, see 302.

To determine the command provided by an operator, a configuration of a control arm may be sensed, or otherwise determined, using one or more sensors at 304. As previously described, in some embodiments, this may correspond to sensing angles between the different linkages and/or of the different rotatable joints or couplings of the control arm. As previously discussed, the commanded pose may be in a controller space which may be linearly mapped onto the desired corresponding movements of the end effector in the world space. This relation between movements in the controller space and the world space may either be linearly scaled up or down depending on the desired application.

Depending on the relative design of a control arm and a portion of a machine to be manipulated to control a pose of an end effector, a transformation from the controller space to a machine space may be needed to implement a desired commanded pose of an end effector. Accordingly, the commanded pose in the controller space may be appropriately transformed into a commanded machine configuration in a machine space. Thus, the method 300 may include transforming the commanded position in the controller space to a commanded machine configuration in a machine space at 306. In embodiments where a control arm corresponds to a similar construction as an arm it is being used to control, the transformation may be a one to one transformation where the sensed angles of the rotatable joints of the control arm in a controller space may be equal to the commanded angles of the joints of the arm of the machine in machine space. However, in other embodiments, more complex transformations (scalar factors, matrix transformations, etc.) may be needed to transform commands form a control arm that has a relatively different construction as compared to a portion of a machine that it is used to operate for controlling motion of an end effector.

In some embodiments, a sensed angle, or other parameter, in a controller space may be transformed to a commanded machine angle in a machine space with a Jacobian matrix. In embodiments where forward kinematics are used to determine the position of an end effector the following equation may be used: \dot{X}=J(θ)·\dot{θ}, wherein X represents an array or matrix of world space coordinates and \dot{X} is the derivative of that array or matrix with respect to time. J(θ) represents the corresponding Jacobian. θ represents an array or matrix of the sensed joint angles and \dot{θ} is the derivative of that array or matrix with respect to time. The θ and J(θ) arrays/matrices represent the same in the above forward kinematics equation as in the below inverse kinematics equation. Without wishing to be bound by theory, a Jacobian is a matrix including all first-order partial derivatives of an associated set of variables. Accordingly, J(θ) is a matrix including all first-order partial derivatives of the θ matrix. In some embodiments, the quantity of degrees of freedom of the machine being controlled is greater than the degrees of freedom of the corresponding control arm.

In embodiments where inverse kinematics are used to determine the joint parameters the following equation is used: \dot{θ}=I_{pseudo}(J(θ))·\dot{X}_{desired}, wherein I_{pseudo}(J(θ)) represents the pseudo inverse of the Jacobian matrix and X_{desired} represents an array or matrix of desired world space coordinates (i.e., a desired path of movement). The pseudo inverse of a matrix is a generalization of an inverse of the matrix. Multiple solutions exist for the \dot{θ} array/matrix for embodiments in which the degrees of freedom in the machine space exceed the degrees of freedom in the controller space. Embodiments using inverse kinematics may also use the assumption that the dimensions of the X and θ matrices are not equivalent. To reiterate, the Jacobian serves to map between two reference frames, specifically the controller space and the machine space. In some embodiments, the actual values being mapped are sensed angles of the control arm.

In embodiments having multiple solutions (i.e., redundant configurations for a commanded position of an end effector), a cost function and/or loss function may be used to help determine which solution will be used to control the machine. As previously mentioned, multiple solutions may exist when there are redundant degrees of freedom in the machine space. Any appropriate cost function and/or loss function may be used, including regret, quadratic loss function, 0-1 loss function, linear quadratic, although any appropriate cost function may be used as the disclosure is not so limited. A rule based decision system may be used to determine which solution will be chosen based on the results of the cost/loss function. This may be helpful in some embodiments as certain configurations and movements of a machine in the world space may be less favorable than others. For example, a first configuration may take more time for the machine to move to than a second configuration that accomplishes the same task. Some configurations may reduce the available amount of travel and/or reduce the available power for a machine, e.g., an arm and boom that are almost approximated adjacent to each other is less desirable than a configuration with the arm and boom spaced apart but with the end effector at the same position. Certain configurations may also be desirable to avoid due to safety risks to the operator and/or potential damage to the machine itself and accordingly are not selected by the rules based decision system. Examples of rule based decisions may include maximizing smoothness, minimizing time or duration of the operation, minimizing maximum torque, minimizing power or fuel consumption, any other appropriate rule based decision, and any appropriate combination thereof. Thus, it should be understood that a rule based decision system and/or a cost or loss function may be implemented in any appropriate way as the disclosure is not limited to any specific implementation of these concepts.

As mentioned above, the operation of a machine in the machine space may result in actual movement of the machine, and the end effector, in world space (i.e., the environment surrounding the machine). As such, operation of the machine may be controlled based on the commanded machine configuration at 308. For example, an excavator may be controlled to move a bucket to a desired pose prior to commencing a digging and/or scooping operation. In another example, a crane may be controlled to move a spreader holding a container both along a length of a boom as well as in a vertical direction. Additionally, while not shown in the method flow diagram, in some embodiments, secondary controls may also be used to control one or more operations of the machine and/or end effector. For example, in the embodiment of FIGS. 1 and 2, the control arm 200 may be moved to a commanded configuration to control a position of the bucket 102 in the world space and the secondary control 220 may be operated to control an orientation of the bucket in the world space.

While not depicted in the above embodiment, in some instances, such as in an excavator, it may be desirable to control a yaw movement of an arm, cab, or other portion of a machine. In such an embodiment, it may be desirable to sense a yaw angle of the control arm. In the embodiment of FIG. 2, this may correspond to sensing a yaw angle of the rotatable coupling 204 connected to the support 206 though other arrangements may also be used. To provide appropriate yaw motion, in some embodiments, yaw movement of the corresponding portion of the machine (e.g., the arm, cab, etc.) may move in a direction corresponding to a rotational direction of offset from a neutral or 0 degree yaw angle (e.g., a straight configuration oriented ahead of an operator). Thus, when the operator yaws the control arm to the left or right the machine may yaw in a corresponding direction. In some embodiments, a velocity of the yaw movement may be proportional to the magnitude of offset of the control arm from the neutral yaw angle. In such an embodiment, it may not be necessary to transform the sensed yaw angle to a desired machine configuration. However, embodiments in which a transformation are applied are also contemplated.

The above method may be implemented by one or more controllers including at least one processor operatively coupled to the various controllable portions of a machine as disclosed herein. The method may be embodied as computer readable instructions stored on non-transitory computer readable memory associated with the at least one processor such that when executed by the at least one processor the control arm, machine, or other system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

Although the present disclosure may be applied to any appropriate machine, a detailed example including a simulator and different construction environments for a hydraulic excavator is presented. The presented example also details a novel world space interface (WS) in the form of a control arm as disclosed herein. Changes in performance of novice operators while operating the excavator using the traditional joint-space joystick interfaces (non-linear map) and the proposed novel world-space interface (linear map) in the simulated environment are also presented.

The inventors developed a three-dimensional excavator simulator that both evaluated the skill of operation of an operator and trained the operator on different interfaces. The simulator simulated multiple different virtual environments which correspond to actual construction sites and the execution of tasks at different levels of difficulty in order to train and evaluate the skill of a naïve operator. In the simulator, a simulated excavator imitated the motion dynamics of an actual excavator by utilizing a physics system that considered both the hydraulic system as well as the mass and inertia of the structural components of the excavator.

The novel WS included linkages representative of an excavator that are scaled down in physical size, potentially affording a more intuitive control scheme to a naïve operator. The WS was similar in construction to the control arm illustrated in FIG. 2. The WS included 4 DOF; one vertical rotation joint for controlling cab rotation, a parallel linkage mechanism for boom and stick, and a secondary control (e.g., a biased lever handle) for the bucket. Springs were coupled to the parallel linkages in the control arm to provide anti-gravity support (i.e., force acting in a direction opposing a local direction of gravity) to at least partially support the weight of the linkages, the handle, the secondary control, and the weight of a human arm. In these experiments, the weight of the arm applied to the WS was assumed to be approximately 3.5 kg. The WS used magnetic rotary encoders, though other sensors may have been used. The secondary control was (e.g., biased lever handle) was coupled to a linear potentiometer via a brake wire to determine the angle of the secondary control. The sensed angle signals were sent to an associated computer through a motor-driver by serial communication. The sensed yaw angle of the support of the WS was converted to cab input velocity using a proportional calculation.

As part of evaluating the WS, the inventors developed a realistic 3D visual simulator to train and evaluate excavator operators performing several common tasks in 19 different environments. The system ran on a high-end computer, processing all the 3D graphics in a high-end graphics card and displaying feedback to an operator using high resolution monitors that displayed the simulated surrounding environment to the operator as if the operator were inside the cab of an excavator. The operator was able to control the virtual 3D excavator using two different physical interfaces: 2 joysticks or the WS detailed above. Like in a real excavator, the operators were able to drive (i.e., operate the treads of the excavator) the virtual excavator using pedals located near feet of the operator or by using the two levers.

The 3D excavator simulator included several discrete modules. An interface module included the monitors, joysticks, levers, and pedals noted above. There were three other modules corresponding to three programs that were executed in real-time simultaneously. One of the three modules was a world-space module, this included obtaining measurements from encoders configured to measure four degrees of freedom (DOF) of the WS and calculated velocities to be sent to the simulator to control the virtual excavator. The four DOF may correspond to the cab (i.e., body), boom, stick, and end effector (e.g., bucket) of the excavator. A log module was used to receive data from the simulator (e.g., velocities, angles, position of the bucket tip, time, etc.) and save the data to a hard drive of the computer without slowing down the 3D simulation. A visual and logic module was used to process all graphics and physics calculations to interact with the 3D simulator and display on the four 4K monitors. A final module was divided into three different blocks. A first block rendered all the 3D simulation including the management of the four virtual cameras (for each monitor), to show the graphical user interface (GUI), and to display the visual effects (VFX) of specific assets (e.g., for the dig and dump tasks). A second block was used for the logic of the movements and interaction of the virtual excavator. The logic of the movements and interactions was programmed to consider dynamics simulating a hydraulic system of an excavator with both simple and realistic behavior, collisions happening in the environment, management for processes such as digging, loading, and dumping dirt, rocks, or other elements in the environments, and recollection of all the desired data to send to store. A third block contained plugins that managed processes that read and write the data to shared memory areas of the computer as part of an Inter-Process Communication (IPC) mechanism used to communicate all the processes of the system in real-time.

Of the 19 environments, there were 15 training environments including tasks such as: digging and dumping sand, dirt, gravel, or mud; removing debris or stones from a road; moving branches and logs from shallow waters; or drilling rocks. These simulated tasks were performed in different environments including construction sites, highways, roads, and riverbeds in various locations such as a city, mountains, forests, rocky hills, mines, or any other appropriate environments.

Training and evaluation sessions were used to collect experimental data from naïve operators including 12 healthy adult males with an average age of 29 who had never operated actual excavators. The operators were divided into 2 groups; the first group trained only with the WS and the second group trained only with the traditional joystick interface (JS). Operators were trained and evaluated in 9 daily sessions. All subjects with WS and JS followed the same protocols (i.e., method or process). The operators completed 14 different tasks to train the operator in different operational skills such as digging, dumping, drilling, rolling, etc. Each task was designed so that the operator could complete the task in approximately 30 minutes. Each operator was trained to operate the excavator in 2 different environments for 30 minutes per day for 7 days.

Prior to the initial training session and following completion of the training protocol, 4 environments were used to evaluate the skill of the operator. In these environments, operators were requested to finish the specially designed tasks as fast as possible. The comparison of the evaluation data before and after the training was used to assess the training's effectiveness. In the first evaluation, repetitive digging and dumping operation skills were measured. The operators dug the sand in the circle around the excavators and dumped it into 8 pipes. The operator dumped the sand into pipes of sequentially decreasing diameter, increasing the necessary positional accuracy of the operator and the difficulty of controlling the position of the end effector. In the second evaluation, simultaneous movements of the cab and other joints were evaluated. The operator made 4 trenches in front of the excavator and dumped the sand into 4 diagonally arranged trenches of varying width and then flattened the surface of these diagonal trenches. The operators generally expressed difficulty in operating the excavator using joysticks along the diagonal lines. In the third and fourth evaluation environments, fine motor coordination was measured. The subjects removed sand along specified slopes which included 4 upwardly angled slopes and 3 downwardly angled slopes with different inclination angles. The operators also expressed that linear movements associated with following the slopes were difficult operations to perform when using the conventional joystick interface.

To evaluate the skill of operators, the inventors considered multiple performance indices. For example, a cycle time for each task was considered. Cycle time was defined as the time duration from the beginning of the digging movement to the completion of the dumping movement for each repetitive attempt. In instances of error during the operation, the time duration of error was excluded. The data corresponding to failures, i.e., controlling the bucket tip directly to the digging and dumping targets and hitting obstacles, was also eliminated prior to analysis.

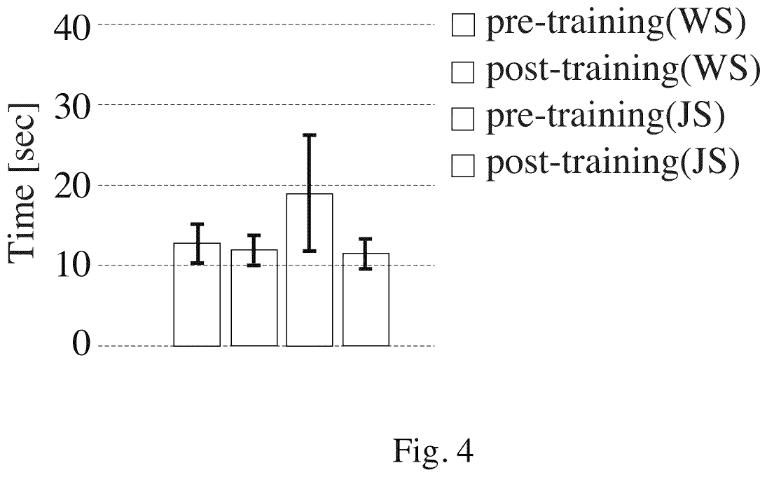

As noted above, the experiments included an operator moving a WS (i.e., a control arm) to control a simulated excavator and collecting data during the operation. The experimental results show that it is easier for a novice or occasional operator to master operation of the machine faster and achieve reasonable results. Specifically, FIG. 4 shows the experimental results for the cycle time in the first evaluation for the operators using the WS.

FIG. 4 shows the outcome of 12 total naïve operators performing a simple dig-to-dump task at day 0 and after training for 7 days. 6 naïve operators used the WS, and the other 6 naïve operators used a JS. The figure compares the average cycle time of 6 naïve subjects using the WS with 6 novices using the pre-training and post 7 days of training. The inventors note that the novice operators using the JS demonstrated a sub-par performance initially but after training improved significantly as they build their internal mental map. Specifically, the subjects using joysticks improved and decreased their cycle time by a statistically significant average of 40% after training. Conversely, the naïve operators using the WS performed better than operators using the JS at day 0 and their performance was almost the same as the second group of operators that trained for 7 days with the JS. Further, the cycle time with WS did not change much with training (i.e., a 6% decrease that was not found to be statistically significant).

The above results suggest that the WS may be a viable alternative for the occasional (i.e., untrained) operators to achieve reasonable outcomes from the onset. Additionally, the average cycle time prior to training with a WS is close to the cycle time with joysticks post-training. This result may indicate that using a WS can potentially help an operator to provide high operability (i.e., skill) even if the operator is untrained. It further indicates that the WS could potentially be implemented in actual excavators to allow naïve operators to start working after basic instructions in the actual sites.

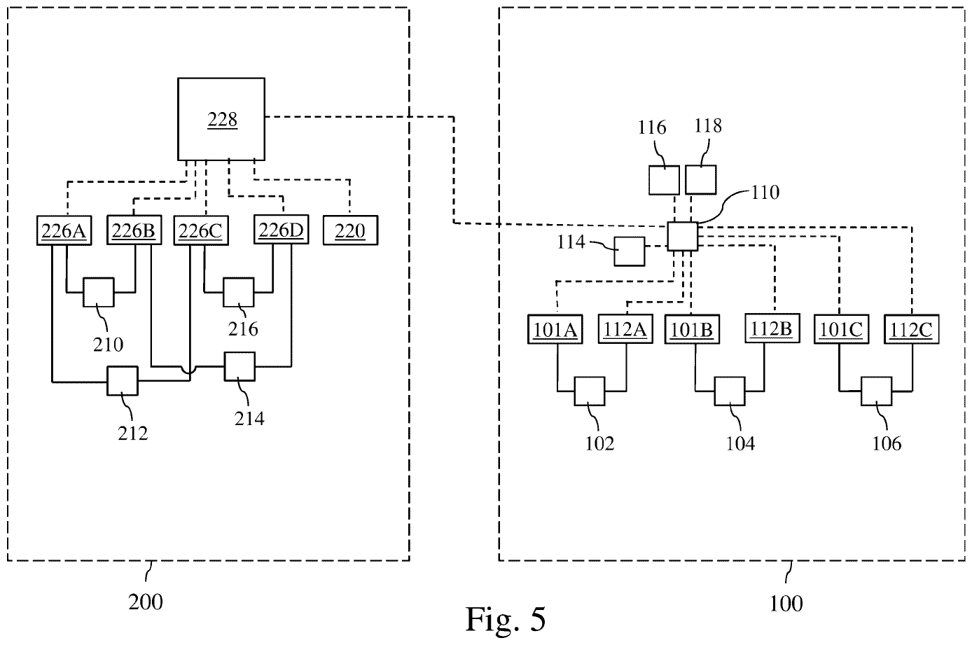

FIG. 5 illustrates a schematic embodiment of a control arm 200 and a machine 100. In the depicted embodiment, the control arm 200 includes a plurality of linkages 210-216 as previously described, or other appropriate arrangement, to control the permitted motion of the control arm. A plurality of sensors 226A-226D may be configured to sense a configuration of the control arm including for instance a configuration of the linkages 210-216. For example, sensors 226A-226D may sense angles between one or more sets of linkages. The sensors 226A-226D may also output one or more corresponding signals to a controller 228 of the control arm 200 which may include one or more processors which may be configured to perform any of the methods disclosed herein related to determining a configuration of the control arm as well as a corresponding command for operation of the machine 100. The control arm 200 may also include a secondary control 220 which may output a control signal to controller 228 to control one or more secondary operations of the machine 100 as detailed previously above. It should be understood that the depicted control arm 200 may also include any of the other components disclosed herein relative to any other embodiment of a control arm as the disclosure is not so limited.

It should be understood that the depicted schematic embodiment of a machine 100 may also include any appropriate component of any of the embodiments of a machine 100 disclosed herein. For example, the machine 100 may optionally include one or more of the operator interface 114, joystick 116, and/or pedals/levers 118 depicted in the figure in instances in which the machine also includes optional typical control interfaces. The machine may also include a controller 110 including one or more processors as well as an appropriate end effector, linkages, or other appropriate motion systems including one or more actuators 112A-112C coupled to the controller 110 to control motion of the machine. For example, the machine is depicted as including a bucket 102, boom 104, and arm 106 which are rotatably coupled to one another as well as actuators 112A-112C configured to control movement of the depicted structures. The actuators 112A-112C may be operatively coupled to the controller 110 which may control motion of the actuators 112A-112C to control motion of the various portions of the machine 100. The machine may also include one or more sensors 101A-101C which may be configured to sense a configuration of the one or more linkages, joints, motion stages, or other moveable portion of the machine such as the depicted bucket 102, boom 104, and arm 106. The one or more sensors 101A-101C may output corresponding signals to the controller 110 which may be used to control operation of the machine 100.

During operation the controller 228 of the control arm 200 may be in communication with the controller 110 of the machine 100. Depending on the embodiment, the determination of a configuration of the control arm 100, transformations between the different reference frames, and determination of commands for the machine 100 may be performed on either controller. Correspondingly, sensed signals, determined configurations, and/or commands in the various reference frames may be transmitted between the two depicted controllers 110 and 228 in any of the disclosed reference frames using any appropriate wired or wireless communication protocol. Correspondingly, the control arm 200 may be remotely located from the machine 100 in some embodiments. However, in some embodiments, the control arm 200 may be integrated with the machine 100. In such an embodiment, the controller 110 and controller 228 may be combined with one another such that the depicted connections and functions may be implemented by a single controller including one or more processors.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

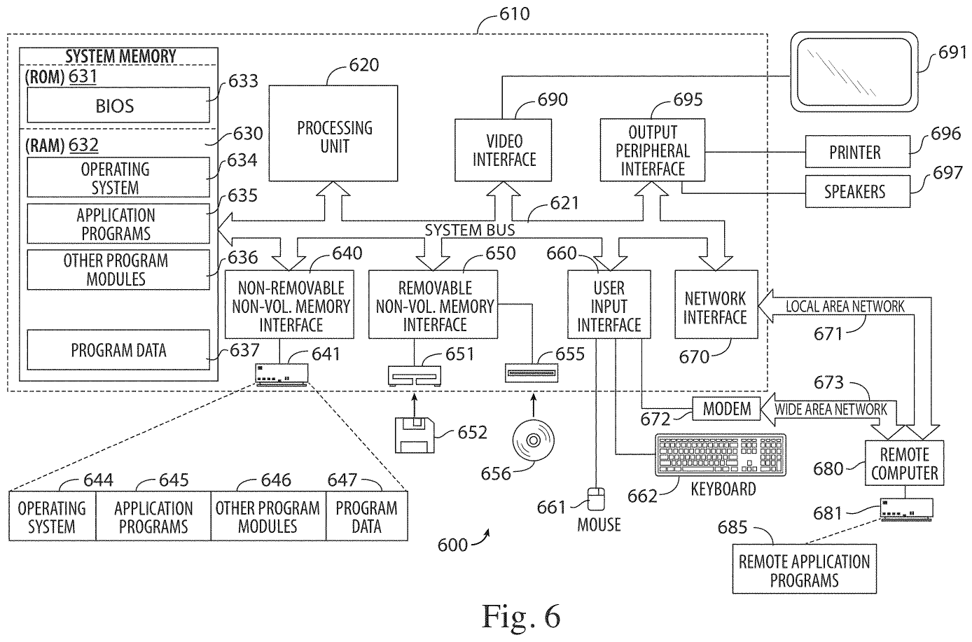

With reference to FIG. 6, an exemplary system for implementing aspects of the disclosure includes a general purpose computing device in the form of a computer 610 or other appropriate computing device. For example, the depicted computing device may be used to control one or more operations of a machine (e.g., an excavator) by implementing any of the methods disclosed herein. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 552, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 510 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673 but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user”, “operator”, or similar term. It should be appreciated that a “user” or “operator” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A system comprising:
a control arm including a plurality of linkages with one or more joints disposed between the plurality of linkages;
a plurality of sensors configured to sense a configuration of the one or more joints of the control arm; and
at least one processor configured to:
obtain a commanded pose for an end effector of a machine in a world space, wherein the commanded pose is in a controller space, and wherein the commanded pose is obtained from the plurality of sensors, and wherein the controller space is linearly mapped to the world space of the machine;
transform the commanded pose from the controller space to a commanded machine configuration in a machine space of the machine; and
control movement of the end effector based at least in part on the commanded machine configuration.

2. The system of claim 1, further comprising the machine, the end effector, and an arm connected to the end effector, wherein the arm is configured to control a pose of the end effector.

3. The system of claim 2, wherein the machine is remotely located from the control arm; or wherein the commanded machine configuration is a commanded joint configuration of a plurality of joints of the arm of the machine.

4. The system of claim 3, wherein the at least one processor is further configured to teleoperate the machine.

5. (canceled)

6. The system of claim 1, further comprising one or more motors and/or springs associated with the control arm, wherein the one or more motors and/or springs are configured to support at least a portion of a weight of the control arm; or wherein obtaining the commanded pose includes sensing angles of the one or more joints of the control arm with the plurality of sensors.

7. (canceled)

8. The system of claim 6, wherein the sensed angles are equal to commanded angles of a plurality of joints of an arm of the machine; or wherein the sensed angles are proportional to commanded angles of a plurality of joints of an arm of the machine.

9. (canceled)

10. The system of claim 1, wherein obtaining the commanded pose includes sensing displacements of the one or more joints of the control arm with the plurality of sensors.

11. The system of claim 10, wherein the sensed displacements are equal to commanded displacements of a plurality of joints of an arm of the machine; or wherein the sensed displacements are proportional to commanded displacements of a plurality of joints of an arm of the machine.

12. (canceled)

13. The system of claim 1, wherein transforming the commanded pose in the controller space to the commanded machine configuration includes transforming the commanded pose using a Jacobian matrix; or wherein the at least one processor is configured to obtain a yaw angle of the control arm with the plurality of sensors and control a yaw movement of the machine based at least in part on the obtained yaw angle.

14. (canceled)

15. A method of controlling operation of a machine including an end effector, the method comprising:
obtaining a commanded pose for the end effector in a world space, wherein the commanded pose is in a controller space, wherein the controller space is linearly mapped to the world space of the machine; and
teleoperating the machine based at least in part on the commanded pose to control movement of the end effector.

16. The method of claim 15, further comprising transforming the commanded pose to a commanded machine configuration in a machine space, and wherein teleoperating the machine includes teleoperating the machine based on the commanded machine configuration to control movement of the end effector.

17. A method of controlling operation of a machine including an end effector, the method comprising:
obtaining a commanded pose for the end effector in a world space, wherein the commanded pose is in a controller space, wherein the controller space is linearly mapped to the world space of the machine;
transforming the commanded pose to a commanded machine configuration in a machine space of the machine; and
controlling movement of the end effector based on the commanded machine configuration.

18. The method of claim 17, wherein obtaining the commanded pose includes obtaining the commanded pose from a world space interface controller.

19. The method of claim 18, wherein the machine is remotely located from the world space interface controller; or further comprising teleoperating the machine with the world space interface controller.

20. (canceled)

21. The method of claim 17, wherein the machine is a simulated machine; or wherein the machine includes an arm associated with the end effector, and wherein the arm includes a plurality of joints; or further comprising transforming the commanded pose in the controller space to the commanded machine configuration using a Jacobian matrix.

22. (canceled)

23. The method of claim 21, wherein the commanded machine configuration is a commanded joint configuration of the plurality of joints.

24. The method of claim 17, wherein obtaining the commanded pose includes an operator moving a control arm to a commanded control arm configuration.

25. The method of claim 24, wherein moving the control arm includes moving a plurality of linkages of the control arm to the commanded control arm configuration; or wherein obtaining the commanded pose includes sensing angles of one or more joints of the control arm.

26. (canceled)

27. The method of claim 25, wherein the sensed angles are equal to commanded angles of a plurality of joints of an arm of the machine; or wherein the sensed angles are proportional to commanded angles of a plurality of joints of an arm of the machine; or wherein obtaining the commanded pose includes sensing displacements of the one or more joints of the control arm.

28. (canceled)

29. The method of claim 27, wherein the sensed displacements are equal to commanded displacements of a plurality of joints of an arm of the machine.

30. (canceled)

31. (canceled)

32. The method of claim 24, further comprising sensing a yaw angle of the control arm and controlling a yaw movement of the machine based at least in part on the sensed yaw angle.

33. A non-transitory computer readable memory including instructions that when executed by at least one processor perform the method of claim 17.
